(19) United States
(12) Patent Application Publication
(10) Pub. No.: US 2001/0033918 A1
(43) Pub. Date: Oct. 25, 2001

(54) Methods for making decorative overlays, foils and decorative moldings

(76) Inventors: Herbert M. Straub, Springfield, MO (US); Martin D. Straub, Springfield, MO (US)

Correspondence Address: RICHARD L. MARSH, 4116 E. LATOKA, SPRINGFIELD, MO, 65809, US

(21) Appl. No.: 09/872,841

(22) Filed: Jun. 1, 2001

Related U.S. Application Data
(63) Continuation-in-part of application No. 09/694,136, filed on Oct. 23, 2000.
(60) Provisional application No. 60/184,021, filed on Feb. 22, 2000.

(51) Int. Cl. B32B 3/00

(52) U.S. Cl. 428/195

(57) ABSTRACT

A decorative molding wrapping foil is derived from a decoration having features specific to a substrate to be decorated. The image of the decoration having features specific to the substrate is first stored as a digital image in a portable image format and thereafter imported into an electronic graphics reader, duplicated at least once thereby creating at least one duplicate image. A portion of one of the duplicate images is laid over the image in one transition zone thereof and a like portion of the image is laid over the duplicate image in a like transition zone thereof thereby creating a continuously repeating image in a ring like manner. The continuously repeating image is imported into a single-pass, multi-color electrostatographic duplex printer where the repeating image is printed upon a wrapping foil for use in foil wrapping of a substrate for use as picture frame element or building trim piece.

### CROSS REFERENCE TO RELATED APPLICATIONS

This application is a continuation-in-part application of U.S. Ser. No. 09/694,136 filed Oct. 23, 2000, which is a non-provisional application under 35 U.S.C. 111 (a) of Provisional Application for Patent, Ser. No. 60/184,021 filed Feb. 22, 2000.

### BACKGROUND OF THE INVENTION

1. Field of the Invention

This invention relates to decorative moldings and methods of making decorative moldings. One method comprises the steps of layering at least one hot transfer foil onto a wrapping film thereby creating a layered wrapping film, thereafter stripping away a carrier of the hot transfer foil, applying an adhesive to an opposite side of the layered wrapping film and wrapping the layered wrapping film about a substrate to be decorated. Another method comprises the steps of creating an electronic image of known decoration, enhancing the electronic image using available image enhancing software, printing multiple sequential copies of the enhanced image, wrapping the multiple copies upon wrapping roll, aligning portions of the enhanced image to a substrate to be decorated and wrapping the substrate to be decorated with the multiple copies of the enhanced image.

2. Prior Art Statement

It is known and practiced by the inventors of this invention to decorate a substrate to be used as a picture frame or building trim piece by providing a decorative surface coating of a thin coat of paint or ink on a thermoplastic or paper transfer carrier and thereafter transferring the decorative surface coating onto at least a portion of a substrate to be decorated while stripping away the carrier.

It is also known and practiced by the inventors to paint a substrate with at least one coat of a specific color of paint, provide a decorative surface coating of a thin coat of paint or ink on a thermoplastic or paper transfer carrier and thereafter transfer the decorative surface coating onto the painted substrate while stripping away the carrier to get a combined effect of the specific color of paint and the thin coat of paint or ink.

It is further known and practiced by the inventors of this invention to provide a decorative surface coating comprising a thin coating of paint or ink on a thermoplastic or paper sheet, applying an adhesive to an opposite side of the sheet and thereafter adhering the decorative surface coating and the sheet onto a substrate to be decorated.

It is also known and practiced by the instant inventors to provide a decorative surface coating comprising a thin coating of paint or ink on a thermoplastic or paper sheet, applying an adhesive to an opposite side of the sheet, adhering the decorative surface coating and the sheet onto a substrate to be decorated and thereafter apply a paint to at least a portion of the decorative surface coating.

Additionally, it is known and practiced by the inventors to wrap over a portion of a substrate to be decorated with a decorative surface coating of a thin coat of paint or ink on a thermoplastic or paper transfer carrier, applying a composition molded into a specific pattern to an unfinished portion adjacent the portion wrapped with the decorative surface coating, drying the composition, painting the composition, thereafter transferring at least a portion of a second decorative surface coating onto at least a portion of the composition.

The inventors are aware that it is known to provide an embossing foil comprising a backing film, a decorative lacquer layer and an adhesive layer wherein the backing film has lacquer applied region-wise to a conventional 3-dimensional pattern thereto such that only those parts not covered by lacquer produce an embossed effect. For instance, see the U.S. Pat. No. 5,635,282 issued on Mar. 7, 1997 to Suess, et al.

Also known is the selective transfer process for applying a metallic film to the raised print produced in a xerographic process described in U.S. Pat. No. 4,724,026 issued on Feb. 9, 1988 to Marshall Nelson. The adhesive side of a transfer sheet is applied face to face with the xerographic sheet with heat and pressure applied to transfer the metallic film from the transfer sheet selectively only to the print on the xerographic sheet. The heating causes the toner to become tacky and thus only applies the film carried on the carrier to the portions containing the toner.

Further known is to produce a texture coat to the adhesive layer of a transfer foil which deflects the multiple print coats above the adhesive layer giving an effect of an embossed foil. The texture coat is a thermoplastic laid down with an embossing roller and is several times thicker than 25 the total thickness of the remaining coats. For instance see the U.S. Pat. No. 4,084,032 issued on Apr. 11, 1978 to John Pasersky.

Yet further known is to produce multi-layered foil laminate coverings for packages wherein both sides of a plastic film material have printing thereon. A first surface is printed and overlaid with an adhesive with this surface then applied to a foil web. The second surface of the plastic film is then printed, overlaid with a lacquer and a dry bond adhesive applied to the lacquer layer. For instance, see the U.S. Pat. No. 5,653,844 issued on Aug. 5, 1997 and U.S. Pat. No. 5,908,527 issued on Jun. 1, 1999 to Richard Abrams.

Additionally, it is known to mark a surface having at least two layers of differently-colored lacquer thereon by exposing region-wise the layer of lacquer remote from the surface to laser radiation to expose the layer of lacquer proximate the surface. For instance, see the U.S. Pat. No. 5,985,078 issued on Nov. 16, 1999 to Suess, et al.

It is further known to create an image in a digital format using available digital cameras or scanners, importing and storing the image in a computer, enhancing the image using various software products and printing single sheet pictures of the enhanced image using laser, inkjet or bubble jet printers. Numerous manufacturers offer these products.

The inventors are also knowledgeable of high speed color printing wherein an image may be printed in a continuous roll on a single-pass, multi-color electrostatographic duplex printer. For instance, see U.S. Pat. No. 6,047,156 issued on Apr. 4, 2000 to De Bock, et al.

Finally, it is known and practiced by the inventors to wrap over opposite edges of a substrate to be decorated with a decorative surface coating of a thin coat of paint or ink on a thermoplastic or paper transfer carrier, providing an unfinished portion of the substrate between the two edges, applying a composition molded into a specific pattern to the unfinished portion, drying the composition, painting the composition, thereafter transferring at least a portion of a second decorative surface coating onto at least a portion of the composition.

### SUMMARY OF THE INVENTION

Manufacturers of lineal picture frame moldings and other decorative moldings utilize numerous processes including application of a stain or paint upon of a substrate, hot embossing of a pattern onto a substrate through the use of a hot steel roller intended to enhance the appearance, embossing of a composition such as wood putty applied to a substrate and thereafter applying a finish to the embossed pattern, hot foil stamping of a variety of patterns finished directly onto a profiled substrate through the use of a heated, contoured silicone wheel and wrapping of a surface paper or thermoplastic material using a hot melt adhesive and pressure wheels to wrap the material around the molding. Any of the substrates hereinbefore mentioned usually has a profiled surface extending longitudinally of the substrate. The substrates are various lengths of wood or fiber board of various compositions.

In the instant application, industry standard terms are utilized to refer to heat transfer foils, wrapping films and decorative surfacing. Thus, a wrapping film is a calendered or extruded rigid vinyl film printed with an ink and/or having a pattern embossed thereon. A decorative foil is similar and has been produced of a cellulose paper, these now collectively herein referred to as wrapping films or wrapping foils. A heat transfer foil or hot stamping foil is a coating system applied to a thin Mylar film called a carrier wherein the coating system has been reverse applied to the carrier with a release coat first applied, a decorative pattern then applied followed by a ground coat and an adhesive. Finally, a substrate shall refer to a panel or panel product manufactured from metal, molded or extruded elastomeric material, wood, wood fibers or particles combined with a suitable binder and bonded under heat and pressure, or combinations of the above.

The known processes have served the decorative molding industry well however there are a limited number of inexpensive decorative surface coatings available on a thermoplastic or paper transfer carrier or wrapping films which provide a simulated effect of a combination of decorative moldings. It has been found that sufficient coatings and films to satisfy a continuing growing customer demand for inexpensive real wood grain and other inexpensive combination decorative surface effects are not available in the industry without costly multistage production processes. Also not available are inexpensive, printed wrapping foils having features specific to the substrate to be wrapped wherein these features may comprise different shadings, different colorings or different weathering effects for different portions of the profile of the substrate. Furthermore, the conventional process of producing these decorative moldings comprises the step of preparing a gravure printing plate for each decorative design, each gravure plate costing several thousand dollars, much too costly for the production of short runs of a specific decorative design.

It is, however, an object of this invention to provide decorative wrapping foils having features specific to particular substrates to be decorated by providing a gravure printing roll having multiple decorative designs across the face of the roll such that different decorative wrapping foils having features to specific substrates are printed in a side-by-side manner thus lowering the cost of short runs of decorative designs.

An object of this invention is to provide short runs of decorative designs of different colors by providing a gravure printing roll having multiple decorative designs across the face of the roll such that different decorative wrapping foils having features to specific substrates are printed in a side-by-side manner.

It is an object of this invention is to provide short runs of decorative designs of different effects by providing a first gravure printing roll having multiple decorative designs across the face of the roll such that different decorative wrapping foils having features to specific substrates are printed in a side-by-side manner of one effect in a first pass and a second gravure printing roll having different effects printed on the same roll in a second pass.

Another significant object of this invention is to provide a decorative molding wrapping foil derived from a decoration having features specific to a substrate to be decorated which comprises an image of the decoration having the features specific to the substrate stored as a digital image in a portable image format. The digital image is imported into an electronic graphics reader and thereafter duplicated at least once thereby creating at least one duplicate image, overlaying a portion of one of the duplicate images over the digital image in one transition zone thereof, overlaying a like portion of the digital image over the duplicate image in a like transition zone thereof thereby creating a continuously repeating image in a ring like manner. The continuously repeating image is then imported into a single-pass, multi-color electrostatographic duplex printer which prints the repeating image upon a wrapping foil and wraps the wrapping foil upon a roll for later use in foil wrapping of a substrate for use as picture frame element or building trim piece.

Another significant object of this invention is to produce small quantities of custom laminated decorative wrapping foils in order to satisfy a growing demand for a variety of patterns, profiles, embossing and colors.

Another feature of this invention is to provide a method of creating an image of a decoration having features specific to a substrate to be decorated wherein the image is derived from a previously manufactured wrapping foil. The previously manufactured wrapping foil comprising at least one hot transfer inked foil carried on a carrier wherein the hot transfer inked foil is laminated onto a planar wrapping foil thereby creating a laminated wrapping foil, the laminated wrapping foil having an adhesive applied to a side of the layered wrapping foil opposite the hot transfer foil and wrapped about a substrate to be decorated such as a picture frame element or building trim piece. The laminated wrapping foil and the substrate are then heated sufficiently to effect removal of the laminated wrapping foil from the substrate wherein the laminated wrapping foil is removed from the substrate and substantially flattened into the decoration having the features specific to the substrate.

It is an object of this invention to layer a decorative surface coating of at least one thin coat of paint or ink on a thermoplastic or paper transfer carrier onto a wrapping foil thereby creating a layered wrapping foil, strip away the carrier, apply an adhesive to an opposite side of the layered wrapping foil, wrap the layered wrapping foil about a substrate to be decorated, thereafter removing the layered wrapping foil from the substrate, flattening the removed foil and making an image of the removed, flattened layered wrapping foil thus creating a decoration having features specific to a substrate to be decorated thereby providing many more pattern and color combinations than is available in industry stock foils.

It is an object of this invention to layer a decorative surface coating of at least one thin coat of paint or ink on a thermoplastic or paper transfer carrier onto a decorative foil thereby creating a layered decorative foil, strip away the carrier, apply an adhesive to an opposite side of the layered decorative foil, wrap the layered decorative foil about a substrate to be decorated, thereafter removing the layered wrapping foil from the substrate, flattening the removed foil and making an image of the removed, flattened layered wrapping foil thus creating a decoration having features specific to a substrate to be decorated thereby providing many more pattern and color combinations than are available in industry stock decorative foils.

Still another object of this invention to provide a decorative molding wrapping foil comprising at least one hot transfer inked foil carried on a carrier, the at least one hot transfer inked foil having a portion of the ink thereon removed prior to being laminated onto a planar wrapping foil thereby creating a laminated wrapping foil having portions of the base color of the planar wrapping foil showing therethrough, thereafter removing the layered wrapping foil from the substrate, flattening the removed foil and making an image of the removed, flattened layered wrapping foil thus creating a decoration having features specific to a substrate to be decorated.

Yet another object of this invention to provide a decorative molding wrapping foil comprising at least one hot transfer inked foil carried on a carrier, the at least one hot transfer inked foil having a substantially all of the ink thereon removed prior to being laminated onto a planar wrapping foil thereby creating a laminated wrapping foil having substantial portions of the base color of the planar wrapping foil showing between inked lines thereon to simulate a distressed pattern on a wood grain wrapping foil or a cracked paint pattern on a planar wrapping foil, thereafter removing the laminated wrapping foil from the substrate, flattening the removed foil and making an image of the removed, flattened laminated wrapping foil thus creating a decoration having features specific to a substrate to be decorated.

It is another object of this invention to provide a decorative molding by the method comprising the steps of layering at least opaque or translucent one hot transfer inked foil onto a wrapping foil thereby creating a intermediate layered foil, stripping away the carrier from the inked foil and thereafter layering at least one other opaque or translucent transfer foil onto the intermediate layered foil, stripping away the carrier from the other transfer foil thereby creating a layered wrapping foil for application to a substrate, applying an adhesive to an opposite side of the layered wrapping foil and wrapping the laminate about a substrate to be decorated, thereafter removing the layered wrapping foil from the substrate, flattening the removed foil and making an image of the removed, flattened layered wrapping foil thus creating a decoration having features specific to a substrate to be decorated.

It is yet another object of this invention to provide a decorative molding by the method comprising the steps of layering at least one opaque or translucent hot transfer inked foil carried on a thermoplastic or paper carrier onto an embossed wrapping foil thereby creating a layered embossed foil, thereafter stripping away the carrier from the hot transfer foil, applying an adhesive to an opposite side of the layered wrapping foil and wrapping the layered wrapping foil about a substrate to be decorated, thereafter removing the layered wrapping foil from the substrate, flattening the removed foil and making an image of the removed, flattened layered wrapping foil thus creating a decoration having features specific to a substrate to be decorated.

A further object of this invention to provide a decorative molding by the method comprising the steps creating a pattern directly upon the substrate to be decorated in wrapping machine by applying a thin layer of hardenable material directly upon the substrate, cooling the hardenable material, forming the cooled hardenable material into a raised pattern surrounding depressions using a forming roller and thereafter applying ink from hot transfer roll onto the raised pattern thereafter making an image of the decorative molding having the features of the previously manufactured molding, printing the image in continuous form to produce a decorative wrapping foil simulating the decorative molding.

Still a further object of this invention to provide a decorative molding by the method comprising the steps creating a pattern directly upon the substrate to be decorated in wrapping machine by applying a thin layer of hardenable material directly upon the substrate, applying ink carried on a carrier to the still fluid hardenable material and forming the hardenable material into a raised pattern surrounding depressions using a forming roller upon a back side of the carrier and thereafter cooling the hardenable material and stripping away the carrier thereafter making an image of the decorative molding having the features of the previously manufactured molding, printing the image in continuous form to produce a decorative wrapping foil simulating the decorative molding.

An additional object of this invention to provide a decorative molding by the method comprising the steps of layering at least one opaque and/or translucent hot transfer inked foil carried on a thermoplastic or paper carrier onto an embossed wrapping foil thereby creating a layered wrapping foil, applying a force to a heated pressing roll on the surface of the hot transfer foil carrier opposite the surface having the hot transfer inked foil applied thereto to provide for dramatic embossing and color effects to the texture of the surface of the embossed foil and adhere the hot transfer inked foil to at least a part of the surfaces of the embossed wrapping foil, stripping away the carrier from the hot transfer foil, applying an adhesive to an opposite side of the layered wrapping foil and thereafter wrapping the layered wrapping foil about a substrate to be decorated, thereafter removing the layered wrapping foil from the substrate, flattening the removed foil and making an image of the removed, flattened layered wrapping foil thus creating a decoration having features specific to a substrate to be decorated.

Still a further object of this invention to provide a decorative molding by the method comprising the steps of layering at least one hot transfer inked foil carried on a thermoplastic or paper carrier onto a wrapping foil wherein random lines have been removed from the inked surface of the at least one hot transfer inked foil thereby creating a layered wrapping foil to simulate a cracked painted surface, stripping away the carrier from the hot transfer foil, applying an adhesive to an opposite side of the layered wrapping foil and thereafter wrapping the layered wrapping foil about a substrate to be decorated, thereafter removing the layered wrapping foil from the substrate, flattening the removed foil and making an image of the removed, flattened layered wrapping foil thus creating a decoration having features specific to a substrate to be decorated.

It is still a further another object of this invention to provide a decorative molding by the method comprising the steps of layering at least one hot transfer inked foil carried on a thermoplastic or paper carrier onto an embossed wrapping foil thereby creating a layered wrapping foil, stripping away the carrier from the hot transfer foil and aggressively brushing the surface of the layered wrapping foil on the surface having the hot transfer inked foil applied thereto to vary the texture of the surface of the layered embossed wrapping foil and remove loose portions of the hot transfer ink from some of the surfaces of the layered embossed wrapping foil, applying an adhesive to an opposite side of the wrapping foil and wrapping the layered embossed wrapping foil about a substrate to be decorated, thereafter removing the layered wrapping foil from the substrate, flattening the removed foil and making an image of the removed, flattened layered wrapping foil thus creating a decoration having features specific to a substrate to be decorated.

One other significant feature of this invention is to prepare profile specific embossed patterns which may also be foiled with profile specific inks by separately profiling specific sections of an unembossed wrapping paper or foil, applying at least one hot transfer inked foil carried on a thermoplastic or paper carrier onto at least one specific profile embossing thereby creating a layered embossed wrapping foil having specific profile embossed patterns thereon, stripping away the carrier from the hot transfer foil, brushing at least one specific profile embossing to remove loose portions of the hot transfer ink therefrom, applying an adhesive to an opposite side of the wrapping foil and wrap the layered embossed wrapping foil about a substrate to be decorated, thereafter removing the layered wrapping foil from the substrate, flattening the removed foil and making an image of the removed, flattened layered wrapping foil thus creating a decoration having features specific to a substrate to be decorated.

Finally, it is also an object of this invention to prepare a method of making the mat and mat edging of a framed picture color coordinated with the frame of the picture comprises the steps of creating an image of a framed picture having at least one mat surrounding the picture, storing the image as a digital image in a portable image format, creating an image of a decoration to be applied to the frame of the picture, storing the image of the decoration as a digital image in a portable image format, importing the digital images of the framed picture and the decoration into an electronic graphics reader, overlaying the image of the decoration over at least a portion of the mat surrounding the image of the framed picture thereby creating a composite image of a framed picture with an image of a decoration applied to a mat surrounding the picture, importing the composite image into a single-pass, multi-color electrostatographic duplex printer, printing at least one copy of the composite image upon photographic paper and mounting the copy in a picture frame having the decoration applied to the visible surfaces thereof

### BRIEF DESCRIPTION OF THE DRAWINGS

FIG. 1 is a perspective view of an apparatus used to prepare a known decoration to be imaged by the methods of this invention.

FIG. 2 is a perspective view of a portion of a decorative molding having a layered wrapping foil wrapped therearound wherein the layered wrapping foil has been partially removed from the decorative molding substrate.

FIG. 3 is a top plan view of a portion of an image of a previously manufactured wrapping foil of FIG. 2 as produced in the apparatus of FIG. 1 and a duplicate image thereof, the duplicate image shown overlapping the image in a transition zone wherein the image of the wrapping foil has features specific to the substrate from which the previously manufactured wrapping foil had been removed.

FIG. 4 is a block diagram of the steps in the methods described in this invention.

FIG. 5 is a perspective view of a gravure printing press roll with two printing roll segments shown spaced therefrom.

FIG. 6 is a plan view of a framed picture with coordinated mat edging and frame decoration.

### DESCRIPTION OF THE PREFERRED EMBODIMENTS

While the various features of this invention are hereinafter described and illustrated as a method of creating a decorative molding wrapping foil comprises the steps of creating an image of a decoration having features specific to a substrate to be decorated, storing the image as a digital image in a portable image format, importing the digital image into an electronic graphics reader, duplicating the image thereby creating a duplicate image, overlaying a portion of the duplicate image over the image in one transition zone thereof and overlaying a like portion of the image over the duplicate image in a like transition zone thereof thereby creating a continuously repeating image, importing the repeating image into a printing process, printing the repeating image upon a wrapping foil and wrapping the wrapping foil upon a roll for use in foil wrapping of a substrate for use as picture frame element or building trim piece it is to be understood that the various features of this invention can be used singly or in various combinations thereof creating an image of a decoration, duplicating the image, printing the image and using the printed image as a wrapping foil for a substrate to be decorated as can hereinafter be appreciated from a reading of the following description.

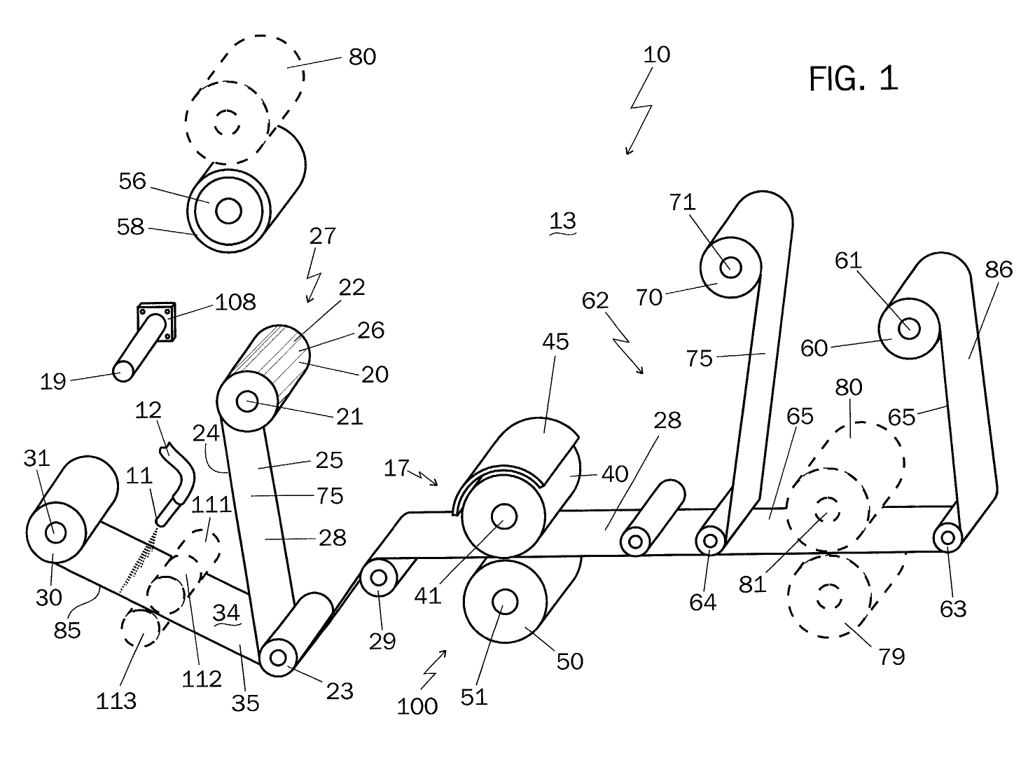

Referring now to FIG. 1, one apparatus to produce a decorative molding wrapping foil for the purposes of this invention is generally shown by the numeral 10 and comprises a first roll 20 of a hot transfer foil 25, a second roll 30 of a wrapping or decorative foil 35, a layering pinch roll set 100 comprising a solid bottom roll 50 and a heated top roll 40, a foil carrier stripping roll 70 and a take up roll 60 for taking up the decorative layered or laminated wrapping foil 65. First roll 20 has at least one thin coat of paint or ink 27 represented by cross hatching 26 applied to the underside 24, as viewed on top 22 of roll 20 in FIG. 1, of a thermoplastic or paper transfer carrier 75 rolled upon roll 20, ink 27 adapted to be mated with and transferred to a surface 34 of wrapping or decorative foil 35. Referring also to FIG. 3, a pattern 37 on wrapping foil 35 is represented by lines 36, wrapping foil 35 having been wound upon roll 30 in a separate process. Though wrapping foil 35 may be purchased from one of the numerous manufacturers of patterned decorative wrapping foils known in the industry, wrapping foil 35 may also be made by passing a flat wrapping foil 35 between at least one patterning roll 111, 112 and a backing roll 113 prior to joining ink 27 to surface 34. Patterning rolls 111, 112 and backing roll 113 are shown in dashed lines between second roll 30 and a first guide roll 23, these rolls 111-113 added to apparatus 10 when patterning of wrapping foil 35 is desired. Likewise, first transfer foil 25 with carrier 75 has also been previously wound upon roll 20 in a separate process, preferably purchased directly from a number of hot transfer coating and wrapping companies well known in the industry. Hot transfer foil 25 may be any known transfer foil utilized in the industry and hence may comprise solid color inks or paints, translucent inks or paints, patterned inks or paints, randomly interrupted solid or translucent inks or paints, variegated inks or paints or combinations of the above. Likewise, wrapping foil 35 may comprise any known wrapping foil including but not limited to solid color inks or paints, translucent inks or paints, patterned inks or paints, randomly interrupted solid or translucent inks or paints, randomly embossed solid foils, patterned embossed solid foils interrupted embossed foils and the like.

Continuing to refer to FIG. 1, roll 30 of wrapping foil 35 is mounted upon shaft 31 of apparatus 10 with pattern 37 preferably facing heated top roll 40 while backside 85 bears against solid bottom drive roll 50. Wrapping foil 35 is fed around guide rolls 23, 29 and into the bight 17 of heated top roll 40 and solid bottom drive roll 50 and directed toward a series of guide rolls 62 around roll 63 toward take up roll 60 to be wound thereupon after ink 27 of hot transfer foil 25 has been transferred to surface 34. Shaft 21 has roll 20 of hot transfer foil 25 and carrier 75 wound thereupon with a leading edge of hot transfer foil 25 also fed around guide rolls 23, 29 and into bight 17 of rolls 40, 50. Roll 20 is placed on shaft 21 such that surface 24 having ink 27 thereupon is directed toward surface 34 of wrapping foil 35. Ink 27 is therefore only visible on top side 22 of roll 20 as it is on the underside surface 24 of carrier 75 and hence is not visible except as shown in FIG. 1. Surfaces 24 and 34 are thus arranged in face to face relationship such that as transfer foil 25 and wrapping foil 35 come into contact in bight 17, ink 27 is transferred to pattern 37 of wrapping foil 35 creating layered or laminated foil 65 of the two separate materials 27, 37. As hot transfer foil has ink 27 sandwiched between a release coat on carrier 75 and an adhesive as a top layer coat, ink 27 readily transfers to surface 34 of wrapping foil 35. Wrapping foil 35 is then utilized to wrap at least a portion of an elongated, profiled section of framing or trim substrate utilized in picture frames or building construction as is fully appreciated by those skilled in the art.

In order that ink 27 on hot transfer foil 25 transfers to wrapping foil 35, heated top roll 40 is heated by a heating plate 45 to a transfer temperature commensurate with the ink 27 being transferred. Heating plate 45 is mounted in close contact with roll 40 and has a heating coil energized by an energy source. As shown in FIG. 1, heating plate 45 curves about at least a portion of roll 40 and has the heating coil mounted thereupon wherein the heating coil is preferably an electrical coil supplied with electrical energy from an energy source such as line voltage from any electrical source. Alternately, heating plate 45 could be heated by a steam or hot water source wherein the heating coil comprises a fluid heat transfer coil. Heated top roll 40 is preferably a soft silicone roll which can deform slightly as foils 25, 35 pass through bight 17 such that ink 27 may be transferred to the exterior surfaces 33, 39 of pattern 37 as desired. The pressure of heated roll 40 against bottom drive roll 50 may be changed to transfer ink 27 to substantially all of the surfaces 33, 39 of pattern 37 or part thereof in order to create different effects for layered foil 65.

After foils 25, 35 pass through bight 17 and ink 27 is hot transferred to pattern 37, carrier 75 is usually stripped away from layered foil 65 by pulling carrier 75 away from layered foil 65 and passing carrier 75 around roll 64 toward carrier roll 70. Carrier 75 is then wound upon carrier roll 70 to be discarded or recycled for a carrier for another ink or foil. Carrier 75 may also be wound upon roll 60 with layered foil 65 by allowing the complete layered foil comprising layered foil 65 carrier 75 and wrapping foil 35 to proceed along series 62 of rolls around roll 64 to take up roll 60. In either case, layered wrapping foil 65 is wound upon take up roll 60 to be utilized in a separate wrapping process. Though a separate wrapping process is preferable to minimize the number of machine setups in the production line of wrapping a section of a substrate to be decorated, it is to be fully understood here that the apparatus 10 could be utilized in conjunction with a wrapping machine wherein a substrate to be decorated is fed into the wrapping machine underneath or in line with apparatus 10 and layered wrapping foil 65 wrapped thereupon substantially immediately after layered wrapping foil 65 is created in bight 17. In such a combination machine, take up roll 60 would not be utilized as layered wrapping foil 65 would have been directly applied onto a substrate to be decorated though carrier roll 70 would be utilized to receive carrier 75 upon completion of the wrapping process.

Still referring to FIG. 1, it can be readily observed that after passing through bight 17, layered wrapping foil 65 has both pattern 37 and ink 27 thereupon as represented by lines 36 and cross hatching 26 respectively. It is understood here that ink 27 and pattern 37 would normally be visible between carrier 75 and take up roll 60 though this representation is omitted from FIG. 1 for clarity. It is also readily apparent that once ink 27 has been transferred to pattern 37 and layered wrapping foil 65 wound upon take up roll 60, take up roll 60 could be moved to shaft 31 replacing roll 30 with layered wrapping foil 65 whereby layered wrapping foil 65 becomes roll 30 and wherein apparatus 10 could be utilized to transfer another hot foil transfer ink 27 to layered wrapping foil 65. In fact, it is contemplated to apply ink 27 from at least one hot transfer foil 25 to at least one pattern 37 of a wrapping foil 35 wherein multiple passes through apparatus 10 would result in multiple transfer inks 27 being applied to at least one pattern 37 or multiple inks 27 transferred to more than one pattern 37. Thus it is possible to create a multitude of layered wrapping foils 65 utilizing combinations of hot transfer foils 25 and wrapping foils 35 currently available on the market, this multitude of layered wrapping foils 65 providing a greater variety of decorative coatings for picture frames and building trim pieces.

An alternate method of enhancing the effect of applying ink 27 to pattern 37 to produce a layered wrapping foil 65 for a decorative molding comprises the steps of layering at least one hot transfer inked foil 25 carried on thermoplastic or paper carrier 75 onto an embossed wrapping foil 35, stripping away carrier 75 thereby creating a layered embossed wrapping foil 65 as herein recited. This alternate method further applies a brushing force to surface 34 directly on ink 27 after carrier 75 has been stripped away, varying the force of a brushing wheel 80 brushing surface 34 of hot transfer ink 27 to provide for dramatic embossing and color effects to the texture of surface 34 of embossed foil 35 by removing portions of ink 27 not fully adhered to parts of surfaces 33, 39 of embossed wrapping foil 35. As with other wrapping foils 35 and layered wrapping foils 65 of this invention, an adhesive is applied to opposite side 86 of layered wrapping foil 65 and layered wrapping foil 65 is wrapped about a substrate to be decorated. This alternate embodiment is fully described in the parent application, the entire specification incorporated into this application by this reference thereto.

It is understood in the above embodiments, heated top roll 40 presses against top 28 of carrier 75 transferring a portion of ink 27 to the portion of pattern 37 contacted by ink 27, ink 27 adhering to pattern 37 as an adhesive is the outside layer in a hot transfer inked foil 25 and thus faces surface 34 of pattern 37. Heated top roll 40 may be spaced from bottom drive roll 50 by an amount equal to the overall thickness of wrapping foil 35 having pattern 37 thereon and ink 27 and carrier 75 such that only the portion of ink 27 contacting the outermost raised surfaces 33 of pattern 37 is transferred thereto. If a greater transfer of ink 27 to pattern 37 is desired, heated top roll 40 may be spaced from lower drive roll a lesser distance, for instance equal to the overall thickness of wrapping foil 35 less the depth of pattern 37, ink 27 and carrier 75 such that substantially all of surface 34 of pattern 37 receives ink 27 thereon, ink 27 being adhered to pattern 37 by the hot transfer process well known in the art. In either case, transfer carrier 75 may then be stripped away from embossed layered wrapping foil 65 before embossed layered wrapping foil 65 is wound upon take up roll 60. Thus an inked, embossed decorative material is produced for wrapping about a substrate.

In one example of layered decorative molding wrapping foil 65 produced by the apparatus 10 and method utilized therewith, layered decorative molding wrapping foil 65 comprises at least one hot transfer inked foil 25 consisting of at least one thin coat of paint or ink 27 on a thermoplastic or paper transfer carrier 75 laminated onto an embossed or planar wrapping foil 35 thereby creating a laminated wrapping foil 65 wherein laminated wrapping foil 65 is wound upon a roll 60 for use in foil wrapping of a substrate 15 for use as picture frame element or building trim piece. Layered decorative molding foil 65 then has carrier 75 stripped therefrom for application to a substrate 15 wherein decorative wrapping foil 65 thereafter has an adhesive applied to a side 86 opposite decorative wrapping foil 65, decorative wrapping foil 65 then being wrapped about substrate 15 to be decorated. As the thin coat of paint or ink 27 may be any ink coating known in the industry, the apparatus 10 and method described herein provides many more pattern and color combinations than are available in industry stock foils. For instance, thin coat of paint or ink 27 may be translucent colors, opaque colors, metallic materials, variegated colors or iridescent colors. In another example, a decorative molding comprising at least one translucent hot transfer ink 27 is transferred onto a translucent wrapping foil 35 thereby creating a layered translucent wrapping foil 65 wherein an adhesive is applied to side 86 opposite inked surface 34 of wrapping foil 65, wrapping foil 65 then wrapped about a substrate to be decorated. In yet another example, a decorative molding comprising a hot transfer ink 27 is transferred onto at least one opaque or translucent wrapping foil 35 thereby creating a layered wrapping foil 65, carrier 75 then being stripped away, at least one other hot transfer ink 27 being transferred onto layered wrapping foil 65 wherein carrier 75 from the at least one other hot transfer ink 27 is stripped away thereby creating a multiple layered wrapping foil 65, multiple layered wrapping foil 65 thereafter made available for wrapping about a substrate to be decorated.

As recited above, roll 60 having layered wrapping foil 65 wound thereon may be placed upon shaft 21 and ink 27 from another hot transfer inked foil 25 applied thereto, however is it also possible to provide a method of applying a variety of different effect coatings to separate sections 32, 38 of wrapping foil 35 for applying to the same style of substrate to be decorated utilizing one machine set up by applying ink 27 from different foils 25 to the separate sections of wrapping foil 35 to produce a different look to the different sections 32, 38.

Apparatus 10 preferably has shafts for the various rolls and brushes mounted to a plate 13 with a bearing housing 108 wherein plate 11 may be affixed to a wrapping machine but preferably is a stand alone machine used for making short runs of laminated decorative molding foils 65. Shaft 51 and hence back up drive roll 50 are preferably driven by a suitable prime mover at a speed from about 2 to about 200 feet per minute while rolls 20, 30 have a suitable braking device affixed to shafts 21, 31 respectively. Take up roll 60 and carrier stripping roll 70 are also preferably driven by a suitable prime mover and may be driven from the same prime mover as roll 50. Heated top roll 40 preferably is friction driven from bottom drive roll 50 through contact direct contact and may have a brake affixed to shaft 41. Heated top roll 40 also preferably has raising and lowering mechanisms journaled on shaft 41 so top roll 40 may be moved toward or apart from drive roll 50 in order to vary the pressure top roll 40 places upon foils 25, 35 being layered to produce layered wrapping foil 65. Brushing roll 80 is driven by a prime mover associated with shaft 81 and may also have raising and lowering mechanisms journaled on shaft 81 so brush roll 80 may be moved toward or apart from surface 28 of carrier 75.

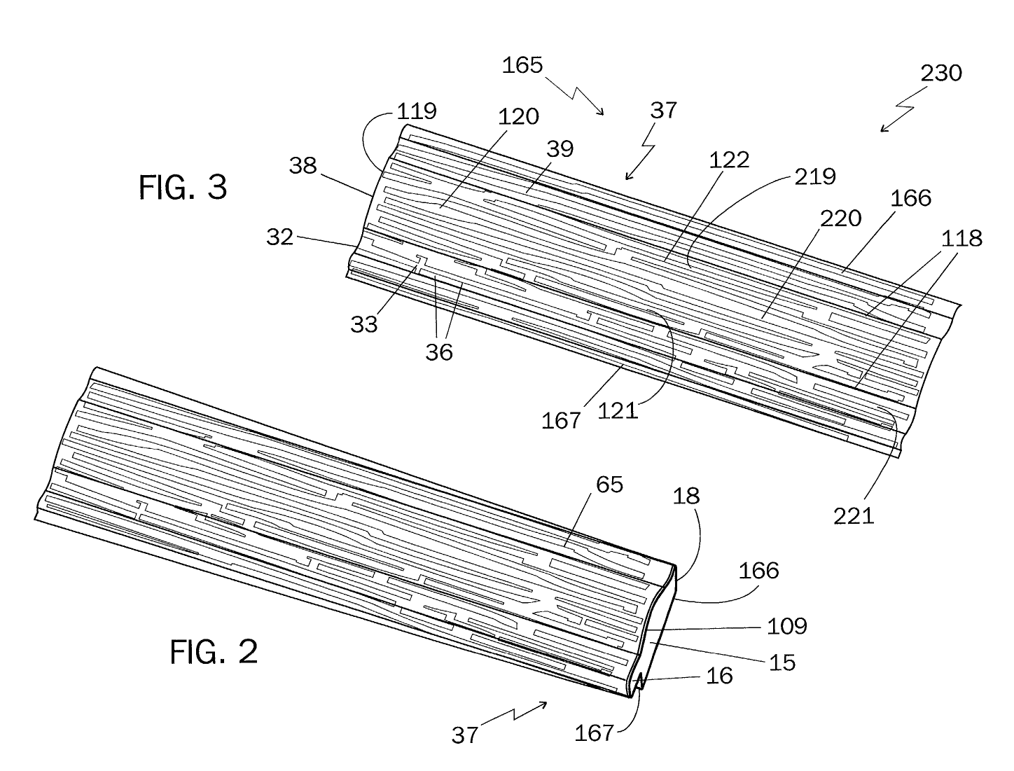

Referring to FIG. 2, a decorative molding has previously been wrapped with a foil 65 made by one of the processes recited in the parent application and in this instant invention a new decorative molding wrapping foil 165 is derived from decorative wrapping foil 65 having features 118 specific to substrate 15 in FIG. 2. Specifically, in FIG. 2, substrate 15 has been wrapped with decorative foil 65 having pattern 37 or other decoration thereon, decorative foil 65 assuming the shape of substrate 15 when wrapped thereupon thereby creating features 118 specific to substrate 15. Features 118 are shown in FIGS. 2 and 3 by shaded areas near edges 16, 18 and over crown 109 of substrate 15. Newly created foil 165 is preferably used on another substrate substantially the same as substrate 15 shown in FIG. 2, however, it is also contemplated that newly created foil 165 may be used on another substrate 15 having features 118 complementary to newly created foil 165.

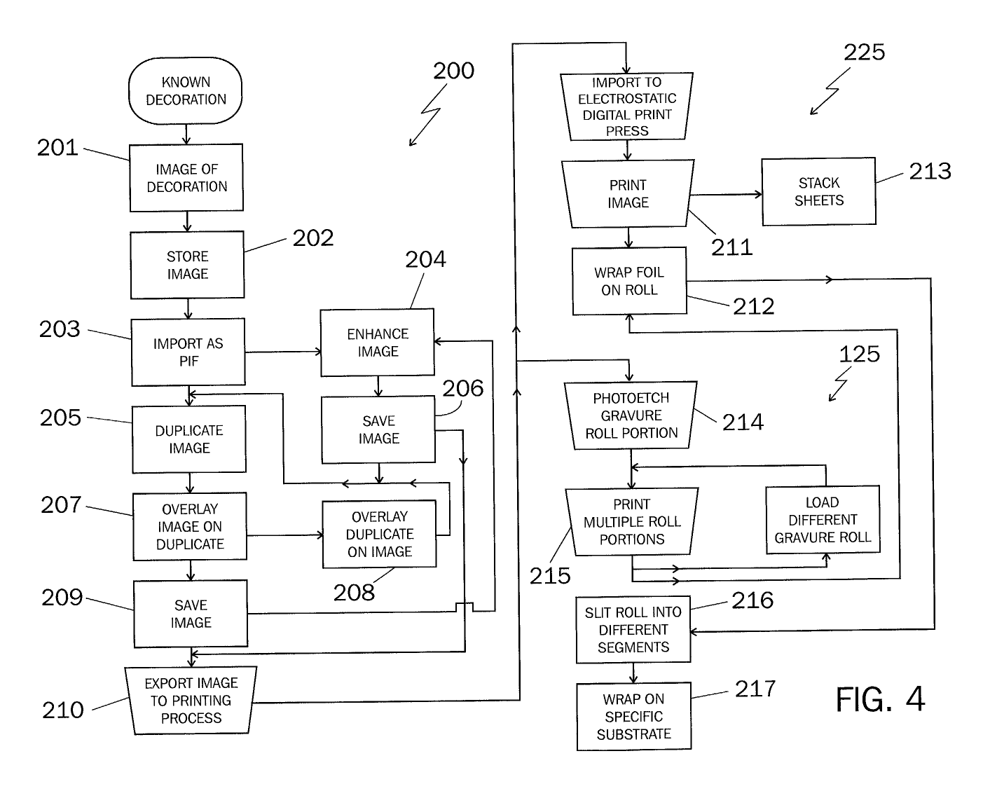

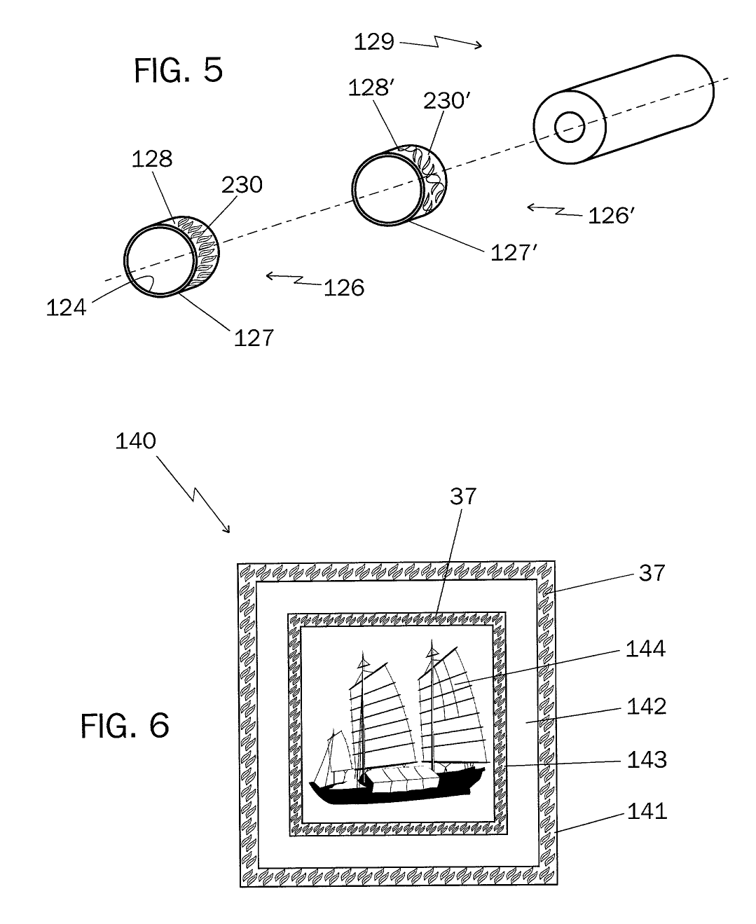

In the instant invention, referring also to FIG. 4, an image 120 of decorative foil 65 having features 118 specific to substrate 15 is created using a scanning device or a digital camera in a first imaging step 201 of the process 200 wherein image 120 is then stored as a digital image in a digital electronic format of a computer which can be read by various image processing programs, hereinafter, a portable image format (PIF). The decorative foil 65 has previously been wrapped about a substrate as is conventional in the art. Substrate 15 and decorative foil 65 are then heated to effect removal of decorative foil from substrate 15 as is shown in FIG. 2 wherein decorative foil 65 is shown wrapped about substrate 15 at the lower right hand side of the figure and effectively removed therefrom throughout the remainder of the figure. It should be noted that the edges of decorative wrapping foil 65 may not have pattern 37 extending fully thereacross as these portions are generally wrapped under substrate 15 and are thus not generally visible. Such a case may occur where decorative wrapping foil 65 has been altered after wrapping about substrate 15. It should be observed in FIG. 2 that contours of substrate 15 have imparted certain effects 118 upon decorative wrapping foil 65, these features 118 becoming a part of image 120. The digital image is then imported into an electronic graphics reader such as Adobe Print Shop or Adobe Photo Deluxe or the like in importing step 203 wherein the digital image is thereafter duplicated at least once thereby creating at least one duplicate image 220 in duplicating step 205. In step 207, a portion 219 of first duplicate image 220 is laid over a portion 121 of digital image 120 in one transition zone 122 thereof, and a like portion 119 of digital image 120 is laid over duplicate image 220 in a transition zone 221 thereof thereby creating a continuously repeating image 230. It should be readily apparent here, that overlaying step 207 may be replicated over and over with successive duplicate images 220 until a continuously repeating image 230 is developed to the length required by the selected printing process and that continuously repeating image 230 may be provided in a ring like manner or as a straight line segment. Next, in step 210, continuously repeating image 230 is exported to a printing process including but not limited to a single-pass, multi-color electrostatographic duplex printing process 225 employing a high speed printer such as Xeikon model DCP/32D or agravure printing process 125. In single-pass, multi-color electrostatographic duplex printing process 225, the printer prints continuously repeating image 230 upon a wrapping foil paper as is well known in the art in step 211 thus creating new decorative wrapping foil 165. In the gravure printing process 125, at least one gravure printing roll 127, 127′ shown in FIG. 5 is first prepared by photo-etching a portion 128, 128′ thereof in step 214 with continuously repeating image 230,230′ wherein gravure printing roll 127, 127′ are mounted upon a gravure printing press roll 129 prior to printing continuously repeating image 230, 230′ upon wrapping foil paper in step 215. Each gravure printing roll 127, 127′ is preferably an annular segment of a gravure printing press roll 129 such that gravure printing press roll 129 thereby comprises a plurality of annular segments 126, 126′. Continuously repeating images 230, 230′ photo-etched upon plurality of annular segments 126, 126′ may be similar but preferably each continuously repeating image 230 is different from any other continuously repeating image 230′ on annular segment 126′. In this manner, economical runs of specific new decorative foils 165 may be accomplished by placing an annular segment 126 having the particular continuously repeating image 230 thereon adjacent another annular segment 126′ having a different continuously repeating image 230′ thereon. In FIG. 5, only two gravure printing segments 127, 127′ are shown each having continuously repeating image 230, 230′ formed thereupon wherein continuously repeating image 230 is shown as being different on gravure printing roll 127 from the continuously repeating image 230′ on gravure printing roll 127′ though it is fully understood here that up to 10 gravure printing roll portions 127 may be arranged in side by side fashion and placed upon gravure printing press roll 129. It should also be understood here that in electrostatographic duplex printing process 225, one continuously repeating image 230 is preferably placed alongside another continuously repeating image 230 in side by side fashion up to the full width of the wrapping foil roll to be printed, these continuously repeating images 230 each chosen for printing as desired by the supplier, wrapping house or customer. By planning specific color runs for gravure printing process 125, the cost of a one roll run of new wrapping foils 165 may be reduced to as little as 0.7 cents per lineal foot. It is thus possible to provide for the growing need for customer specific requests without prohibitive expense to either the producer or the customer.

In either process, new decorative wrapping foil 165 is wrapped upon a roll in step 212 for use in foil wrapping of a substrate having features 118 similar to substrate 15 for use as picture frame element or building trim piece. The roll of new decorative wrapping foil 165 is preferably prepared in multiple widths upon a roll of wrapping foil and thereafter slit into specific width segments in step 216 for use in wrapping upon a specific substrate 15 in a separate wrapping process in step 217. For instance, it is common to use a roll of wrapping foil approximately 30 inches in width and 21000 feet in length in the printing process whereby up to 10 width segments may be provided across the face of the roll. It should be readily apparent here that at least two of the width segments may be similar or all width segments may be different depending upon the images of known decorations created in first imaging step 201. Preferably, each width segment is different thereby establishing 21000 foot long limited length runs of a particular continuously repeating image 230 such that the cost of each segment is kept to a minimum.

Continuing to refer to FIG. 4, preferably a storing step 202 occurs between imaging step 201 and importing step 203 as separate effects may be desired by the customer or supplier on the same image 120 and thus the stored image 120 may be imported into the same or another electronic graphics reader for processing as another new image 120 for another wrapping foil printing process. It is contemplated that any image 120 stored in storing step 202 may be enhanced in an electronic graphics reader by changing the color of image 120, varying the hue thereof, changing the contrast or brightness, applying an optical enhancement to a portion thereof and/or preparing the negative of digital image 120. For instance, in an image 120 prepared from a known section of picture frame or trim molding, the grooves of substrate 15 may be considerably darker in color than adjacent areas wherein if left unchanged would essentially print so dark as to appear black on new image 120 without regard to the original color. Thus, the area of image 120 corresponding to the grooves of substrate 15 may be enhanced by changing one, two or all of the hue, contrast or brightness of the area of the grooves to produce new image 120 having different shades of the color of the known section as is properly represented in the known section. Of course, it is also possible within the scope of this invention to change any of the other characteristics of new image 120 in combination with any or all of the other characteristics. Preferably, upon completion enhancing of new image 120 in enhancing step 204, the enhanced image 120 is saved digitally in step 206 for reference in preparation of future images 120. After saving new image 120 in step 206, new image 120 may then proceed through duplicating step 205 and overlaying step 207 and again be saved in a second saving step 209 or may proceed directly to exporting step 210. New image 120 may also be replicated through duplicating and overlaying steps 205, 207 and 208 to create the length necessary for the selected printing process. Second saving step 209 is inserted into process 200 between the final overlaying step 207 and exporting step 210 in order that continuously repeating image 230 is available for another run of new decorative wrapping foil 165. Optical enhancement usually consists of raise the gloss of a portion of a decoration to make that portion appear to stand out or be raised from the printed surface. It is also possible to lower the gloss of a portion of a decoration to make that portion appear to be depressed below the printed surface of the remainder of the decoration.

As features 118 are derived from the shape of substrate 15 the contour of each substrate produces color, color density and or hue variations in image 120. For instance, a deeper hue usually exists in depressed contours whereas a lighter hue is present on raised contours of a picture frame or trim molding due to lighting effects playing upon the molding. Furthermore, in moldings having peeling paint, the higher contours peel more readily and thus display more of an underlying color whereas the lower or depressed contours have had a thicker paint applied and therefore are most likely have less peeling and are deeper in color than the un-peeled portions of higher portions. Other effects appear on edges 16, 18 of substrate 15 and the portions 166, 167 wrapped under edges 18, 16 respectively. In portions 166, 167 it is generally unimportant what pattern, color or effect is present however, it has been found in the teachings of this invention to continue pattern 37 across the entire width of new decorative wrapping foil 165 and thus in enhancing step 204, pattern 37 is generally extended across the full width of image 120. It should be readily apparent that other effects present on existing moldings may also be enhanced in enhancing step 204.

Another alternative to enhancing image 120 in the electronic graphics reader is to prepare image 120 of a decoration having features 118 specific to a substrate 15 to be decorated wherein the decoration on substrate 15 has previously had a portion thereof painted by an individual thereby creating a specific effect upon the known decoration. An image 120 prepared therefrom may also be enhanced through process 200 and printed upon a new wrapping foil paper to produce new decorative wrapping foil 165. Certain features 118 to be hand prepared by an individual prior to imaging include, but are not limited to, the class including contour lines, shading, weathering, damage, edging.

It is also contemplated by the inventors to overlay a portion of image 120 side by side with another portion of image 120 thus extending image 120 in a width wise relationship to produce an alternate effect for new decorative wrapping foil 165. In fact, it is also contemplated to overlay one pattern 37 of one image 120 upon another pattern 37 of another image 120 to produce yet another alternate effect. Yet another alternative is to provide an embossing station utilizing an image 120 to create an embossing pattern 37 upon an embossing roll similar to gravure printing roll 127 wherein new decorative wrapping foil 165 may be embossed upon completion of printing step 211, 215 by pressing the embossing roll upon new decorative wrapping foil 165 either before but preferably after printing image 120 thereupon.

When wrapping a substrate 15 with new decorative wrapping foil 165, it is important to align features 118 of new decorative wrapping foil 165 with complementary features on substrate 15. For instance, the feature 118 over crown 109 should be aligned with crown 109 while feature 118 adjacent edge 166 should be aligned with edge 18 of substrate 15. Some new decorative wrapping foils 165 will have significant features created by shadows of the image, depressions in the underlying substrate or may be affixed thereon by hand before image 120 is created or input onto image 120 after importing the PIF into the computer. In fact, is it possible, while image 120 is in a PIF, to enhance various characteristics thereof. As previously set forth, it is contemplated by the inventor herein that at least one characteristic of digital image 120 be enhanced before duplicating digital image 120 in duplicating step 205. Preferably, certain characteristics of image 120 are specifically modified in the PIF to create a variety of new decorative wrapping foils 165. For instance, these characteristics include color, hue, contrast, brightness and/or the negative of the digital image, these characteristics selectively applied to the whole of digital image 120 or parts thereof as desired by the customer, supplier or manufacturer.

A method of making the mat and/or the mat edging of a framed picture coordinated with the frame of the picture is another alternate valuable feature of this invention. Referring now to FIG. 6, the method of making the mat 142 and/or mat edging 143 comprises the steps of creating an image 120 of framed picture 140 having at least one mat 142 surrounding the picture 144 and storing image 120 as a digital image in a portable image format in imaging step 210. Additionally, the process comprises another step of creating an image 120′ of a decoration to be applied to frame 141 of framed picture 140 and storing image 120′ of the decoration as a digital image in a portable image format. Both digital image 120 of framed picture 140 and digital image 120′ of the decoration are then imported into an electronic graphics reader in importing step 203 wherein image 120′ of the decoration is laid over at least a portion of mat 142 or mat edging 143 surrounding image 120 of framed picture thereby creating a composite image 120″ of framed picture 140 with image 120′ of a decoration applied to a mat 142 and/or mat edging 143 surrounding picture 144. The composite image 120″ is then imported image into a single-pass, multi-color electrostatographic duplex printer wherein at least one copy of composite image is printed upon photographic paper and the printed copy is mounted a picture frame 141 having coordinated decoration applied to the visible surfaces thereof Either or both of image 120, 120′ may be enhanced in enhancing step 204 and thereafter saved for further use in saving step 206 prior to exporting to printing process 225. It is usual to provide multiple copies of composite image 120″ in printing process 225 and therefore the multiple copies are generally stacked in sheet form in stacking step 213.

While the present invention has been described with reference to the above described preferred embodiments and alternate embodiments, it should be noted that various other embodiments and modifications may be made without departing from the spirit of the invention. Therefore, the embodiments described herein and the drawings appended hereto are merely illustrative of the features of the invention and should not be construed to be the only variants thereof nor limited thereto.

We claim:

1. A method of making a decorative molding wrapping foil comprises the steps of creating an image of a decoration having features specific to a substrate to be decorated, storing said image as a digital image in a portable image format, importing said digital image into an electronic graphics reader, duplicating said image thereby creating a duplicate image, overlaying a portion of said duplicate image over said image in one transition zone thereof and overlaying a like portion of said image over said duplicate image in a like transition zone thereof thereby creating a continuously repeating image, importing said repeating image into a printing process, printing said repeating image upon a wrapping foil and wrapping said wrapping foil upon a roll for use in foil wrapping of a substrate for use as picture frame element or building trim piece.

2. The method as in claim 1 wherein at least one characteristic of said digital image is enhanced before duplicating said digital image.

3. The method as in claim 2 wherein said at least one said characteristic is selected from the group comprising, color, hue, contrast, brightness, optical enhancement or the negative of said digital image.

4. The method as in claim 3 wherein said printing process is a gravure roll printing process.

5. The method as in claim 4 wherein said repeating image is photo-etched upon a portion of at least one gravure printing roll.

6. The method as in claim 5 wherein said at least one gravure printing roll is an annular segment of a gravure printing press roll, said gravure printing press roll thereby comprising a plurality of annular printing roll segments.

7. The method as in claim 6 wherein said repeating image photo-etched upon said plurality of annular segments is similar.

8. The method as in claim 3 wherein said printing process is a single-pass, multi-color electrostatographic duplex printer.

9. The method as in claim 1 wherein said wrapping foil is unrolled from said roll, has an adhesive applied to a reverse side thereof and is wrapped around a substrate to be decorated.

10. The method as in claim 9 wherein said features on said image specific to said substrate to be decorated are aligned with said substrate to be decorated said wrapping foil caused to adhere to said substrate by said adhesive.

11. A method of creating an image of a decoration having features specific to a substrate to be decorated, said image derived from a previously manufactured wrapping foil, said previously manufactured wrapping foil comprising at least one hot transfer inked foil carried on a carrier, said at least one said hot transfer inked foil laminated onto a planar wrapping foil thereby creating a laminated wrapping foil, said laminated wrapping foil having an adhesive applied to a side of said layered wrapping foil opposite said hot transfer foil, said laminated wrapping foil wrapped about a substrate to be decorated such as a picture frame element or building trim piece, wherein said laminated wrapping foil and said substrate are heated sufficiently to effect removal of said laminated wrapping foil from said substrate, said laminated wrapping foil being removed from said substrate, said laminated wrapping foil thereafter substantially flattened into said decoration having said features specific to said substrate.

12. The method as in claim 11 wherein said image is stored as a digital image in a portable image format.

13. The method as in claim 12 wherein said digital image is imported into an electronic graphics reader.

14. The method as in claim 13 wherein said digital image is duplicated at least once in said electronics graphics reader thereby creating n+1 duplicate images, overlaying a portion of a first said duplicate image over said digital image in one transition zone thereof, overlaying a portion of each successive one of said n+1 duplicate images over each previous one of said n+1 said duplicate images in a transition zone thereof thereby creating a continuously repeating image.

15. The method as in claim 14 wherein said continuously repeating image is imported into a single-pass, multi-color electrostatographic duplex printer, said continuously repeating image repeated in side by side fashion from one side edge to an opposite side edge of a wrapping foil roll to be printed, printing said continuously repeating image in said side by side fashion upon said wrapping foil, wrapping said wrapping foil upon a roll for use in foil wrapping of a substrate for use as picture frame element or building trim piece.

16. The method as in claim 15 wherein at least one of said repeating images repeated in said side by side fashion is different in color from at least one other of said repeating images repeated in said side by side fashion.

17. The method as in claim 15 wherein at least one of said repeating images repeated in said side by side fashion is different in hue from at least one other of said repeating images repeated in said side by side fashion.

18. The method as in claim 15 wherein at least one of said repeating images repeated in said side by side fashion is different in contrast from at least one other of said repeating images repeated in said side by side fashion.

19. The method as in claim 15 wherein at least one of said repeating images repeated in said side by side fashion is different in brightness from at least one other of said repeating images repeated in said side by side fashion.

20. A decorative molding wrapping foil derived from a decoration having features specific to a substrate to be decorated comprises an image of said decoration having said features specific to said substrate stored as a digital image in a portable image format, wherein said digital image is imported into an electronic graphics reader, said digital image thereafter duplicated at least once thereby creating at least one duplicate image, overlaying a portion of one of said duplicate images over said digital image in one transition zone thereof, overlaying a like portion of said digital image over said duplicate image in a like transition zone thereof thereby creating a continuously repeating image, importing said repeating image in a single-pass, multi-color electrostatographic duplex printer, printing said repeating image upon a wrapping foil and wrapping said wrapping foil upon a roll for use in foil wrapping of a substrate for use as picture frame element or building trim piece.
